(19) United States
(12) Patent Application Publication
(10) Pub. No.: US 2011/0110700 A1
(43) Pub. Date: May 12, 2011

(54) DEVICE FOR APPLYING FUSIBLE PRODUCTS

(75) Inventor: Luis Martinez De San Vicente Oliveras, Cornella de Llobregat (ES)

(73) Assignee: CERAS ESPECIALES MARTINEZ DE SAN VICENTE, S.A., Cornella de Llobregat (ES)

(21) Appl. No.: 13/002,269

(22) PCT Filed: Jul. 2, 2009
(86) PCT No.: PCT/ES2009/000356

§ 371 Date: Dec. 30, 2010

(30) Foreign Application Priority Data
Jul. 3, 2008 (ES) P200801985

(51) Int. Cl. B05C 9/14

(52) U.S. Cl. 401/1; 401/208

(57) ABSTRACT

The invention relates to an applicator device for fusible products, such as depilatory wax, comprising a casing open at the upper part, like a receptacle, grippable with a hand and intended to contain a reservoir suitable for storing hot wax and provided with an upper dispensing opening, above which at least one roller rotating about its longitudinal axis and housing therein heating means is arranged by support means.

### TECHNICAL FIELD OF THE INVENTION

The invention relates to an applicator device for a fusible product such as depilatory wax, of those comprising a casing open at the upper part, like a receptacle, intended to contain a reservoir suitable for storing the hot fusible product and provided with an upper dispensing opening above which at least one main roller rotating about its longitudinal axis is arranged, the purpose of which roller is to spread a layer of the molten product forming a film.

### BACKGROUND OF THE INVENTION

The depilation technique by the application of a thermofusible product, such as for example depilatory wax, consists of making a certain amount of this product, which is in solid or pasty state at room temperature, melt and of applying a layer of the molten product on the area which is to be depilated, After the hardening, i.e., after the cooling, the film of cold wax is removed with the aid of any suitable means, the hair then being extracted from the skin because of their embedment in the wax.

Depilatory wax applicators provided with an interchangeable wax reservoir and with heating means for increasing the temperature of the stored wax are currently known, which wax is heated until reaching the suitable temperature for keeping it sufficiently liquid so that it can be spread.

To meter the wax, the devices incorporate a main wax-distributing roller which allows depositing the wax in thin layers on the skin.

During the application process, the hot wax coming out of the reservoir comes into contact with the outer surface of the main applicator roller, which is at a temperature considerably lower than that of the wax, therefore cooling of the wax occurs. This causes the wax to adhere to the main roller and makes its homogeneous application more difficult. Another direct consequence is that the wax cools in an undesired manner, hardening quickly and preventing the formation of a film as desired.

One of the consequences is that the time during which the applicator can be used decreases, and it is necessary to heat the wax stored in the reservoir again for its subsequent application.

It is therefore an objective of the present invention to disclose an applicator preventing the accumulation of cold wax adhered to the main applicator roller.

To provide a solution for the drawbacks described, the use of components outside the applicator which incorporate heating means is known, which components are placed on the main roller while it is not operating, for example, while other external heating means heat the wax stored in the reservoir. By means of this solution it is achieved that the outer temperature of the main roller is not so cold when the use of the applicator is started. According to a specific solution described in patent document EP 0368698, there is a cover provided with heating means which is placed on the head of the applicator and which covers the area of the main applicator roller. This cover is removable and is removed when the applicator must be used. The fact of adding external heating elements to the main roller considerably increases the complexity of the product and thus its production cost.

The literature generically describes some variants of applicator devices for fusible products which are not suitable, due to their size, for applying depilatory wax or which lack casings of the type open at the upper part, in which a main applicator roller provided with heating means is described. Nevertheless, said documents do not specify embodiments or detail the way in which said heating means are electrically powered. This is the case of documents U.S. Pat. No. 5,980,144 or WO 98/56275, respectively. Therefore, another objective of the invention is a simple and highly cost-effective constructive solution for an applicator suitable for dispensing depilatory wax the main applicator roller of which is heated.

### DISCLOSURE OF THE INVENTION

The device according to the invention is an applicator device for fusible products, such as depilatory wax, of those comprising a casing open at the upper part and grippable with a hand, like a receptacle, intended to contain a reservoir suitable for storing hot wax and provided with an upper dispensing opening, above which at least one main roller rotating about its longitudinal axis is arranged by support means.

Although the applicator is especially intended for the application of depilatory wax, it is capable of being used to dispense another type of product, such as polishes or the like.

The applicator according to the invention is essentially characterized in that the main roller houses therein heating means, the main roller being formed from a thermally conductive material. Thermally conductive is understood, in the field of the invention, as a material which allows transmitting the heat generated inside the main roller to its outer surface, such that the wax in contact with said surface does not harden quickly.

According to a variant of the invention, the heating means are fixed to the support means of the applicator device and the main roller is assembled rotating about the mentioned heating means. According to this variant, there is a relative movement between the main roller and the heating means during the application of the wax.

According to another variant of the invention, the heating means are supported in the main roller and rotate together with it.

According to an embodiment of the invention, the main roller is hollow and is provided with respective end lids, each of which is provided with a support pivot on the support means, at least one of them being provided with a central through hole communicating with the inside of the main roller and through which the heating means are introduced in the main roller or they are connected with a power supply outside the main roller.

According to a variant of the invention, the heating means are supported in the main roller and rotate together with it.

Since the excessive cooling of the wax upon contacting the surface of the main roller is prevented, its adhesion to the skin of the user is improved and therefore its adherence to the main roller is decreased. Nevertheless, to reduce even more the amount of wax which may be adhered to the main roller, the device comprises, in a particular variant of the invention, two rollers, one of them being the main roller housing the heating means and the other one being an auxiliary roller arranged parallel to the main roller, a separation band being determined between both. The device furthermore comprises transmission means for transmitting the movement between the main roller and the auxiliary roller, the rotation direction transmitted to the auxiliary roller being opposite to the rotation direction of the main roller.

Thus, the wax which is not adhered to the skin of the user is driven by the main roller and the auxiliary roller to a hot area of the device again, which is the area of the dispensing opening of the reservoir, in which the cooled wax will be heated again and conditioned for its dispensing.

According to another feature of this variant of the invention, the transmission means comprise first and second gear wheels, meshing with one another, the first gear wheel being coupled to the shaft of the main roller and the second gear wheel being coupled to the shaft of the auxiliary roller.

The possibility of the auxiliary roller housing therein auxiliary heating means is contemplated, the auxiliary roller being formed from a thermally conductive material.

It has been possible to verify that this feedback effect caused by the auxiliary roller in collaboration with the main roller also occurs even in the event that the main roller and/or the auxiliary roller lack associated heating means. Furthermore, this effect persists even when the previously heated roller starts to cool.

The object of the invention is therefore an applicator device in which above the dispensing opening of the reservoir storing hot wax there are arranged a main roller, intended to dispense a film of molten wax, and an auxiliary roller, arranged parallel to the main roller and a separation band being determined between both rollers, the device furthermore comprising transmission means for transmitting the movement between the main roller and the auxiliary roller, the rotation direction transmitted to the auxiliary roller being opposite to the rotation direction of the main roller.

According to another feature, the diameter of the auxiliary roller is smaller than the diameter of the main roller, and the transmission means are suitable for the angular rotation speed transmitted to the mentioned auxiliary roller to be greater than that of the main roller.

It is understood that the separation band between the main roller and the auxiliary roller is suitable enough so that the cold wax adhered to the main roller can be compressed and driven by the rollers towards the upper dispensing opening of the reservoir.

### BRIEF DESCRIPTION OF THE DRAWINGS

The attached drawings show, by way of a non-limiting example, two preferred embodiments of the applicator device object of the invention. In said drawings,

FIG. 1 is a section elevational view of a first variant of the device object of the invention;

FIG. 2 is an exploded view of the variant of the applicator device for wax of FIG. 1;

FIG. 3 is a section detailed view of the head of the applicator device for wax of FIG. 1;

FIG. 4 is a section detailed view of the head of an applicator device for wax according to another embodiment variant of the invention.

FIG. 5 is a view of the head of a variant of the applicator device for wax comprising a main roller and an auxiliary roller;

FIG. 6 is a detailed view of the gear for transmitting movement of the main roller, heated or not, to the auxiliary roller of the head of FIG. 5; and

FIG. 7 is a simplified and perspective view of the device of FIG. 1 in which the head comprising a single main roller has been substituted with the head depicted in FIG. 5, and shown in a correlative fitting position.

### DETAILED DESCRIPTION OF THE DRAWINGS

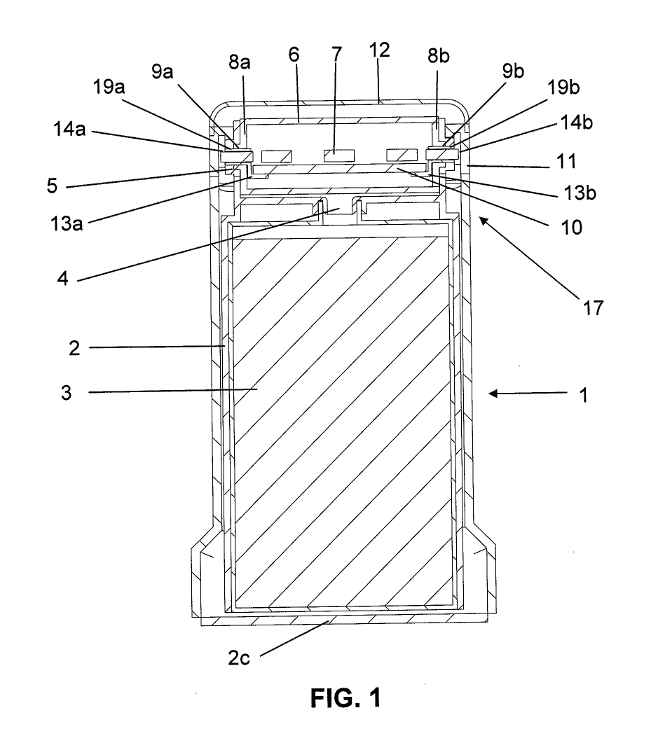

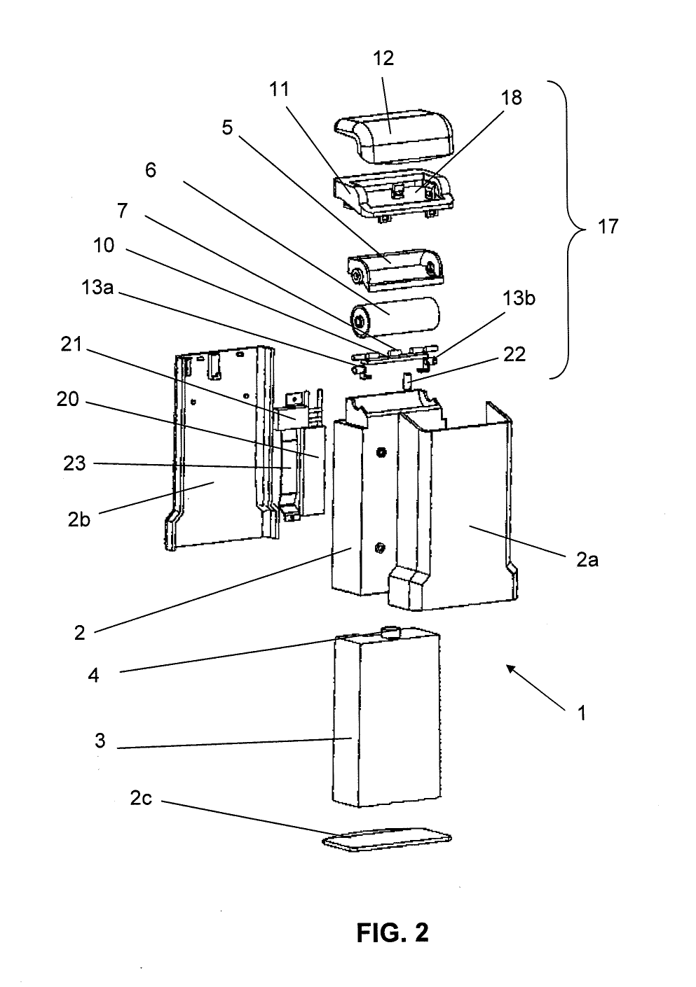

The device 1 depicted in FIG. 1 is especially intended for the application of depilatory wax. Said device 1 comprises a casing 2, open at the upper part, housing therein, with tightness, a reservoir 3 provided with an upper opening 4 and suitable for storing hot wax. In the example depicted in FIG. 2, the casing 2 is introduced in an enveloping body formed by two half-parts 2a and 2b, and by a lower lid 2c, which fit together to form a receptacle suitable for housing the mentioned casing 2, and for thermally insulating it from the outside.

The device 1 furthermore comprises, in a known manner, means for the heating of the wax stored in the reservoir 3, for the purpose of increasing its temperature and keeping it in a sufficiently fluid or molten state for its application. These means for the heating of the wax stored in the reservoir 3 are formed by a PTC thermistor 20; which is applied against the outer surface of the casing 2; a thermostat 21; a pilot light or led 22; and a strip 23 keeping the PTC thermistor 20 applied against the casing 2.

As can be observed in FIGS. 1 and 2, in the casing 2 there is coupled a head 17 comprising a main roller 6 rotating about its longitudinal axis; support means 5 of the main roller 6; a cover 11 and a lid 12.

The support means 5 are formed by an oblong part which, like a frame, surrounds the main roller 6 and supports it by its ends. These support means 5 are fixed to the casing 2 by means of a cover 11 which is provided with a groove 18, in the direction of the main roller 6, through which the outer surface of the latter emerges, allowing its actuation when it is slid on the skin of the user, and thus spreading the wax coming out of the opening 4 of the reservoir 3.

The upper part of the cover 11 can be protected by means of a lid 12, removably couplable to the cover 11, for the purpose of preventing dirt from being introduced inside the head 17 when the applicator device 1 is not in use. In a characteristic manner, the main roller 6 is hollow and houses therein heating means 7, formed by a circuit board 10 with resistors in series, which generate heat when they are powered with an electric current. The generated heat is transmitted by convection to the body of the main roller 6 and by conduction to the outer surface of said main roller 6, whereby the temperature of the wax, after coming out of the opening 4, does not decrease as quickly as occurs in conventional applicators. Furthermore, the heating of the main roller 6 allows, upon using the applicator device 1 again after a first use, the cooled wax remains which may have remained adhered to the main roller 6, preventing its normal rotation, to melt and avoiding having to clean the main roller 6 manually, the subsequent uses of the applicator device 1 thus being facilitated.

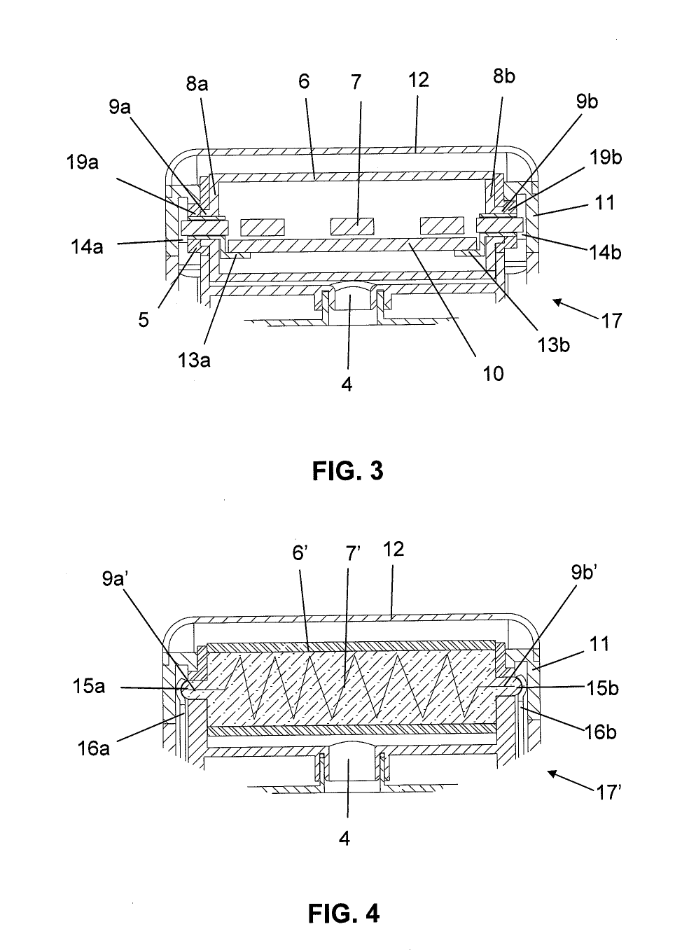

It is observed in FIG. 3 that the support means 5 keep the main roller 6 at a sufficient distance from the opening 4 of the reservoir 3 to allow the exit of the molten wax in a controlled manner and to form a film of wax applicable on the skin of a user.

It is furthermore observed in the variant of FIG. 3 that the main roller 6 is hollow, and that it is supported in the support means 5 through respective support pivots 9a and 9b provided for such purpose at the side ends thereof. In turn, the support means 5 are provided with two recesses 19a and 19b which, like a housing, receive the fitting of a corresponding support pivot 9a or 9b, each with possibility of rotation.

To prevent wax remains from entering the inside of the main roller 6, the support pivots 9a and 9b of the main roller 6 fit with certain tightness in the recesses 19a and 19b of the support means 5, however the heating means 7 pass through the support pivots 9a and 9b with certain clearance, such that the rotation of the main roller 6 is not hindered by the rubbing against the mentioned heating means 7.

In the embodiment variant of FIG. 3, the heating means are formed by a circuit board 10 containing resistors in series which emit heat when an electric current is passed through them. The circuit board 10 is fixed, by means of respective fixing elements 13a and 13b, to the support means 5, the heating means extending from one end of the support means 5 to the other, longitudinally traversing the main roller 6. The mentioned main roller 6 is provided with end lids 8a and 8b, one of which can actually be formed by a base portion integrally formed with the cylindrical body of the main roller 6, in which there are formed the respective hollow support pivots 9a and 9b, and through which the heating means 7 are introduced inside the main roller 6.

To power the heating means 7, the device 1 incorporates conductive receivers 14a and 14b in the support means 5 which connect said heating means 7 to a power supply outside the device 1, such as the mains supply, or inside it, such as a battery.

FIG. 4 shows another embodiment of the head 17′ in which, unlike the embodiment of FIGS. 1 to 3, the heating means 7′ form part of the main roller 6′ such that they rotate together with it. In this case, the main roller 6′ is solid and the heating means 7′ are formed by an integral resistive filament of the main roller 6′. The bases 8a′ and 8b′ of the main roller 6′ are provided with respective support pivots 9a′ and 9b′ with a cylindrical shape and finished in semispherical metal terminals 15a and 15b electrically connecting the resistive filament located inside the main roller 6′ with power supply means outside the main roller 6′.

To be able to power the resistive filament, the casing 2 has a pair of metal brushes 16a and 16b setting up electrical connection with the metal terminals 15a and 15b, respectively. To ensure the electrical connection, the metal brushes 16a and 16b are elastically deformed in the contact position and the parts intended to contact the metal terminals 15a and 15b have a semispherical shape, complementary to that of the mentioned metal terminals 15a and 15b.

The end of the metal brushes 16a and 16b opposite to the head 17′ is connected to the power supply means of the device 1, such that, through the pair of metal brushes 16a and 16b electricity is supplied to power the heating means 7′ and, therefore, heat the main roller 6′

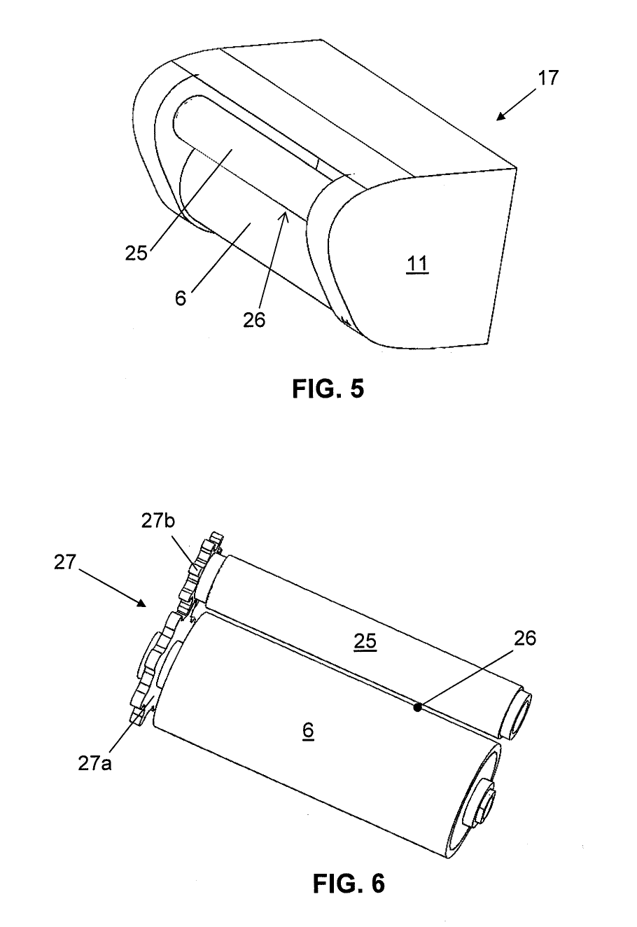

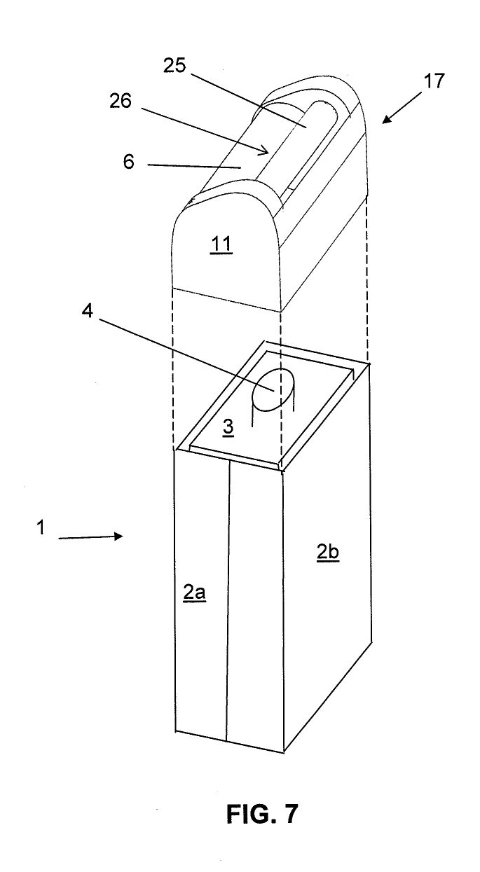

FIG. 5 shows the head 17 of a variant of the device 1 incorporating a main auxiliary roller 25 assembled on the cover 11 and rotating together with the main roller 6, favoring the reintroduction of the excess wax during the wax application phase into the cover 11. It is thus favored that the excess wax which would otherwise accumulate outside the cover 11, slowing down and making the rotation of the main roller 6 difficult, is again introduced inside the cover 11 through the clearance or separation band 26 formed between the main roller 6 and the main auxiliary roller 25. When the wax is introduced again inside the cover 11, the latter is again heated by contact with the hot wax coming out of the opening 4 of the reservoir 3, therefore being able to be recycled.

To achieve the effect of introduction of the excess wax into the cover 11, the applicator device is provided with transmission means 27 for transmitting the rotation movement of the main roller to the auxiliary roller 25, by means of which said auxiliary roller 25 is forced to rotate in the direction opposite to the main roller 6 and at greater speed, for example five times faster. In the variant depicted in FIG. 6, the transmission means 27 are mechanical transmission means comprising a gear with first and second gear wheels 27a, 27b, fixed to the shafts of the main roller 6 and of the auxiliary roller 25 respectively. The gear ratio of the gear must therefore be the suitable one so that the main roller 6 and the main auxiliary roller 25 rotate in opposite directions to compress and drive the wax adhered on the main roller 6.

During the wax spreading phase, the main roller 6 is actuated upon being applied against the skin of the user, actuating the first gear wheel 27a transmitting the movement to the second gear wheel 27b and in turn to the auxiliary roller 25 in a direction opposite to the rotation direction of the main roller 6, therefore aiding in reintroducing the excess wax and preventing it from accumulating and spilling outside the cover 11.

Naturally, the main auxiliary roller 25 can also comprise auxiliary heating means, similar to those shown inside the main rollers of the depicted variants, to aid in keeping the excess wax at a temperature high enough for it to remain sufficiently fluid so that it can be easily reintroduced through the separation band 26.

It should be stated that the effect caused by the arrangement of two rollers in the manner described and depicted in FIGS. 5 and 6 also occurs, although to a lesser extent, when the main roller 6 and/or the auxiliary roller 25 lack heating means. Although the optimal solution for extending the use of the applicator device, i.e., for prevent cold wax from being adhered to the main roller, is that in which the device is simultaneously provided with a main roller and a auxiliary roller, at least the main roller being heated, a device incorporating a main roller and an auxiliary roller, without any of them being provided with associated heating means, is also effective, although to a lesser extent.

1. An applicator device for fusible products, such as depilatory wax, of those comprising a casing open at the upper part and grippable with a hand, like a receptacle, intended to contain a reservoir suitable for storing hot wax and provided with an upper dispending opening, above which at least one main roller rotating about its longitudinal axis is arranged by support means, characterized in that said main roller houses therein heating means, the main roller being formed from a thermally conductive material.

2. The device according to claim 1, characterized in that the heating means are fixed to the support means of the applicator device and in that the main roller is assembled rotating about the mentioned heating means.

3. The device according to claim 1, characterized in that the main roller is hollow and is provided with respective end lids, each of which is provided with a support pivot on the support means, at least one of the pivots being provided with a central through hole communicating with the inside of the main roller and through which the heating means are introduced in the main roller or they are connected with a power supply outside the main roller.

4. The device according to claim 1, characterized in that the heating means are supported in the main roller and rotate together with it.

5. The device according to claim 1, characterized in that the heating means longitudinally traverse the main roller.

6. The device according to claim 1, characterized in that it comprises two rollers, the main roller housing the heating means and an auxiliary roller arranged parallel to the main roller, a separation band being determined between both, and transmission means for transmitting the movement between the main roller and the auxiliary roller, the rotation direction transmitted to the auxiliary roller being opposite to the rotation direction of the main roller.

7. The device according to claim 1, characterized in that the transmission means comprise first and second gear wheels, meshing with one another, the first gear wheel being coupled to the shaft of the main roller and the second gear wheel being coupled to the shaft of the auxiliary roller.

8. The device according to claim 6, characterized in that the auxiliary roller houses therein auxiliary heating means, the auxiliary roller being formed from a thermally conductive material.

9. An applicator device for fusible products, such as depilatory wax, of those comprising a casing open at the upper part and grippable with a hand, like a receptacle, intended to contain a reservoir suitable for storing hot wax and provided with an upper dispensing opening, characterized in that above the dispensing opening there are arranged a main roller, intended to dispense a film of molten wax, and an auxiliary roller, arranged parallel to the main roller and a separation band being determined between both rollers, and in that the device furthermore comprises transmission means for transmitting the movement between the main roller and the auxiliary roller, the rotation direction transmitted to the auxiliary roller being opposite to the rotation direction of the main roller.

10. The device according to claim 9, characterized in that the diameter of the auxiliary roller is smaller than the diameter of the main roller, and in that the transmission means are suitable for the angular rotation speed transmitted to the mentioned auxiliary roller to be greater than that of the main roller.

11. The device according to claim 10, characterized in that the separation band between the main roller and the auxiliary roller is suitable so that the cold wax adhered to the main roller can be compressed and driven by the rollers towards the upper dispensing opening of the reservoir.
